(19) United States
(12) Patent Application Publication
(10) Pub. No.: US 2008/0115479 A1
(43) Pub. Date: May 22, 2008

(54) Pressurized coal gasifier and coal gasification combined cycle power plant

(75) Inventor: Ken Tamura, Tokyo (JP)

Correspondence Address: BIRCH STEWART KOLASCH & BIRCH, PO BOX 747, FALLS CHURCH, VA, 22040-0747, US

(73) Assignee: Mitsubishi Heavy Industries, Ltd.

(21) Appl. No.: 11/600,729

(22) Filed: Nov. 17, 2006

(51) Int. Cl. F02B 43/00; C10J 3/68

(52) U.S. Cl. 60/39.12; 48/77

(57) ABSTRACT

Provided is a pressurized coal gasifier in which a general low head pump can be used, abrasion damage of a control valve and pump due to flushing can be prevented and maintenance cost and device cost can be reduced. Also, provided is a coal gasification combined cycle power plant that can efficiently use gas generated by the pressurized coal gasifier for power generation. In a pressurized coal gasifier for thermally processing a coal material under pressure to be gasified, the gasifier having a bottom portion thereof provided with a water tank (4) for water-granulating a slag, the water tank being connected with one end of a feed water pipe (5) and one end of a drain pipe (6), the other ends of the feed water pipe and drain pipe are connected so as to communicate with each other to form a circulating channel (7) of closed system and the circulating channel is provided with a cooler (8) and circulating pump (9) of circulating water.

### BACKGROUND OF THE INVENTION

1. Field of the Invention

The present invention relates to a pressurized coal gasifier and a coal gasification combined cycle power plant.

2. Description of the Prior Art

There is known a coal gasifier in which solid carbon material, such as coal, is fed into a gasifier under a pressurized high temperature atmosphere so that combustible components of the material are gasified and heat thereof is recovered as well as a slag as ash component of the material is fed into a quenching water storage of a gasifier bottom portion so that the slag is granulated by water (water-granulated) to be discharged (See Patent Document 1). Also, in the water tank for water-granulating the slag, there is provided a monitoring device for detecting a falling-down state of the slag by image or sound signal, such as a camera for image monitoring or a falling-down sound collector for collecting a falling-down sound of the slag (See Patent Document 2). For cooling and protecting this monitoring device as well as for preventing flushing of slag water at the slag discharging time, a slag water circulating and cooling system is provided on the water tank.

As an example of a slag water circulating portion of the pressurized coal gasifier, there is one as shown in FIG. 7 that has been disclosed by the applicants here. In FIG. 7, a gasifier 3 is shown only by its bottom portion in which a water tank 4 is provided (the same applies also to FIGS. 1 to 4). In a slag water circulating channel of the gasifier 3, slag water discharged from the water tank 4 is led into a slag settling tank E under the atmospheric pressure so that the slag mixed in the slag water is settled and removed. Then, the water in a feed water tank F is pumped up by a booster pump A to flow through a filter B, cooler C, slag feed water pump D, circulating water flow meter F1 and circulating water flow control valve CV1 so that the water is circulated to be again supplied into the water tank 4 of the gasifier 3. The water is cooled at the cooler C and is supplied into the water tank 4. Thereby, the water in the water tank 4 is also cooled.

In FIG. 7, numeral 5 designates a feed water pipe, numeral 6 a drain pipe, numeral T1 a slag hopper water outlet temperature gauge, numeral T2 a cooler outlet temperature gauge, numeral L1 a water level meter, numeral CV2 a water level control valve, numeral 11 a lock hopper, numerals 12 and 13 opening and closing valves and arrow S a molten slag.

As a matter of course, the water flowing through the slag water circulating channel contains the slag and also the water after having passed through the filter B contains a small amount of residual slag components. Thus, at the time of draining from the high pressure gasifier 3 into the atmospheric pressure or at the time of water-feeding from the atmospheric pressure into the gasifier 3, there is a possibility to cause an abrasion damage due to flushing on the downstream side of the control valves or in the pumps and this leads to a problem that a long term continuous operation is made difficult.

Also, the pressure in the gasifier 3 is 1 to 10 MPa and in order to realize this pressure, it is necessary to elevate the pressure of feed water. Thus, the slag feed water pump D must be employed from large capacity high head pumps having a high abrasion resistant function or from pumps arranged with in-line multiple stages and this also leads to a problem of cost increase.

| | |
|---|---|
| [Patent Document 1] | Japanese laid-open patent application |
| | 1995-109471 (FIG. 1) |
| [Patent Document 2] | Japanese laid-open patent application |
| | 2004-91571 (FIG. 1) |

### SUMMARY OF THE INVENTION

In view of the problems in the prior art devices, it is an object of the present invention to provide a pressurized coal gasifier in which a general-purpose low head pump can be employed, an abrasion damage of control valves or pumps due to flushing can be prevented and a reduction of maintenance cost or device cost can be achieved. It is also an object of the present invention to provide a coal gasification combined cycle power plant in which generated gas from this pressurized coal gasifier can be effectively used for power generation.

In order to achieve the above-mentioned objects, the present invention provides means of the following (1) to (7):

(1) As a first means, a pressurized coal gasifier for thermally processing a coal material under pressure to be gasified, the gasifier having a bottom portion thereof provided with a water tank for water-granulating a slag, the water tank being connected with one end of a feed water pipe and one end of a drain pipe, wherein the other ends of the feed water pipe and drain pipe are connected so as to communicate with each other to form a circulating channel of closed system and the circulating channel is provided with a cooler and circulating pump of circulating water.
(2) As a second means, a pressurized coal gasifier as mentioned in the first means, wherein the water tank or circulating channel is provided with a water temperature detecting device and there is provided a temperature adjusting means for adjusting water temperature in the water tank to a predetermined set temperature based on a temperature signal from the water temperature detecting device.

It is to be noted that the term “to adjust the temperature to a predetermined set temperature” as mentioned above means “to adjust the temperature of the water in the water tank to be lower than the boiling point temperature at the atmospheric pressure”. As the temperature adjusting means, such a means as to increase or decrease a circulating water flow rate to be supplied into the water tank or to make a cooling capacity of the cooler variable is considered.

(3) As a third means, a pressurized coal gasifier as mentioned in the second means, wherein the circulating channel is provided with a circulating water flow control valve and the circulating water flow control valve is controlled to be opened or closed based on the temperature signal from the water temperature detecting device.
(4) As a fourth means, a pressurized coal gasifier as mentioned in the second means, wherein a discharge quantity of the circulating pump is controlled to be increased or decreased based on the temperature signal from the water temperature detecting device.
(5) As a fifth means, a pressurized coal gasifier as mentioned in the second means, wherein a cooling medium flow rate of the cooler is controlled to be increased or decreased based on the temperature signal from the water temperature detecting device.

### (6) As a sixth means, a pressurized coal gasifier as mentioned in any one of the first to fifth means, wherein the circulating channel is provided with a filter device that is on-line washable.

(7) As a seventh means, a coal gasification combined cycle power plant, wherein the power plant comprises the pressurized coal gasifier as mentioned in any one of the first to sixth means as well as comprises a heat exchanger provided in a gas discharge channel of gas gasified by the pressurized coal gasifier, dust collector for removing dust in the gas, gas turbine driven by gas from the dust collector, heat recovery steam generator for generating steam by discharge gas of the gas turbine and steam turbine driven by generated steam from the heat exchanger and heat recovery steam generator, and power is generated by drive force of the gas turbine and steam turbine.

According to the pressurized coal gasifier as mentioned in the first means and as claimed in Claim 1, the circulating channel is made by the closed system. Hence, as compared with the conventional open system circulating channel, differential pressure between an inlet and outlet of the pump becomes small so that employment of the conventional large capacity high head pump becomes unnecessary and a general low head circulating pump can be used. Thereby, a large cost reduction becomes possible. Also, as the slag water discharge quantity from the high pressure gasifier into the atmospheric pressure becomes less as compared with the conventional cases, piping of the circulating channel and the pump itself are hardly abraded and a long term continuous operation of the gasifier becomes possible.

Moreover, by the cooler cooling the circulating water and the circulating pump continuously and circularly supplying the water, water temperature in the water tank of the gasifier can be always maintained to a low temperature. Hence, a slag monitoring device or the like can be well preserved and flushing of the slag water also can be prevented. Thereby, a reduction of maintenance cost of the pump and piping becomes possible. Also, as the slag water can be used by circulation, quantity of the water used becomes less and load of waste water treating facilities can be reduced.

According to the pressurized coal gasifier as mentioned in the second means and as claimed in Claim 2, the same function and effect as mentioned with respect to the first means can be obtained. Moreover, even if the load or operational state of the gasifier changes, the water temperature in the water tank can be always appropriately maintained to the set temperature. Hence, an accurate temperature control of the water temperature in the water tank becomes possible and a stably controlled operation of the gasifier can be carried out. This results in a further reduction of the maintenance cost.

According to the pressurized coal gasifier as mentioned in the third means and as claimed in Claim 3, the same function and effect as mentioned with respect to the second means can be obtained. Moreover, by the circulating water flow control valve being controlled to be opened or closed, quantity of the water supplied into the water tank of the gasifier can be increased or decreased and the water temperature in the water tank can be adjusted and maintained to the set temperature. Thereby, a stably controlled operation of the gasifier can be carried out. Also, in case the circulating water flow control valve is controlled toward a throttling direction, power to drive the circulating pump can be reduced.

According to the pressurized coal gasifier as mentioned in the fourth means and as claimed in Claim 4, the same function and effect as mentioned with respect to the second means can be obtained. Moreover, by the discharge quantity of the circulating pump being controlled to be increased or decreased, quantity of the water supplied into the water tank of the gasifier can be increased or decreased and the water temperature in the water tank can be adjusted and maintained to the set temperature. Thereby, a stably controlled operation of the gasifier can be carried out.

According to the pressurized coal gasifier as mentioned in the fifth means and as claimed in Claim 5, the same function and effect as mentioned with respect to the second means can be obtained. Moreover, by the cooling medium flow rate of the cooler being controlled to be increased or decreased, temperature of the water supplied into the water tank of the gasifier can be adjusted and the water temperature in the water tank can be maintained to the set temperature. Thereby, a stably controlled operation of the gasifier can be carried out.

According to the pressurized coal gasifier as mentioned in the sixth means and as claimed in Claim 6, the same function and effect as mentioned in any one of the first to fifth means can be obtained. Moreover, by the filter being on-line washed, that is, by the filter being washed while the gasifier is being operated, filtering of the slag water can be efficiently carried out and abrasion of the circulating pump and clogging of the cooler can be prevented. Thereby, a long term continuous operation of the gasifier can be ensured.

According to the coal gasification combined cycle power plant as mentioned in the seventh means and as claimed in Claim 7, the same function and effect as mentioned in any one of the pressurized coal gasifiers of the first to sixth means can be obtained. Moreover, gas energy of the generated gas generated by the pressurized coal gasifier can be efficiently used and a long term stable power generation can be realized.

### BRIEF DESCRIPTION OF THE DRAWINGS

FIG. 1 is a circulating channel diagram of a water tank of a pressurized coal gasifier of embodiment 1 according to the present invention.

FIG. 2 is a circulating channel diagram of a water tank of a pressurized coal gasifier of embodiment 2 according to the present invention.

FIG. 3 is a circulating channel diagram of a water tank of a pressurized coal gasifier of embodiment 3 according to the present invention.

FIG. 4 is a circulating channel diagram of a water tank of a pressurized coal gasifier of embodiment 4 according to the present invention.

FIG. 5 is an entire system diagram of a coal gasification combined cycle power plant of an embodiment according to the present invention.

FIG. 6 is a channel diagram showing another embodiment of a filter device usable in the embodiments 1 to 4 according to the present invention.

FIG. 7 is a circulating channel diagram of a water tank of a pressurized coal gasifier in the prior art that has been proposed by the applicants here.

### DESCRIPTION OF THE PREFERRED EMBODIMENTS

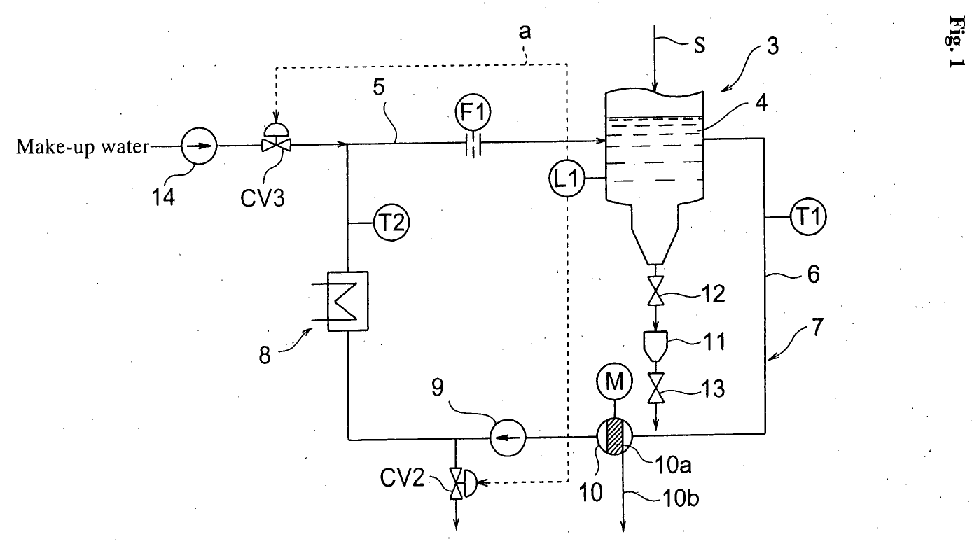

A pressurized coal gasifier and a coal gasification combined cycle power plant according to the present invention will be described based on embodiments thereof with reference to FIGS. 1 to 6.

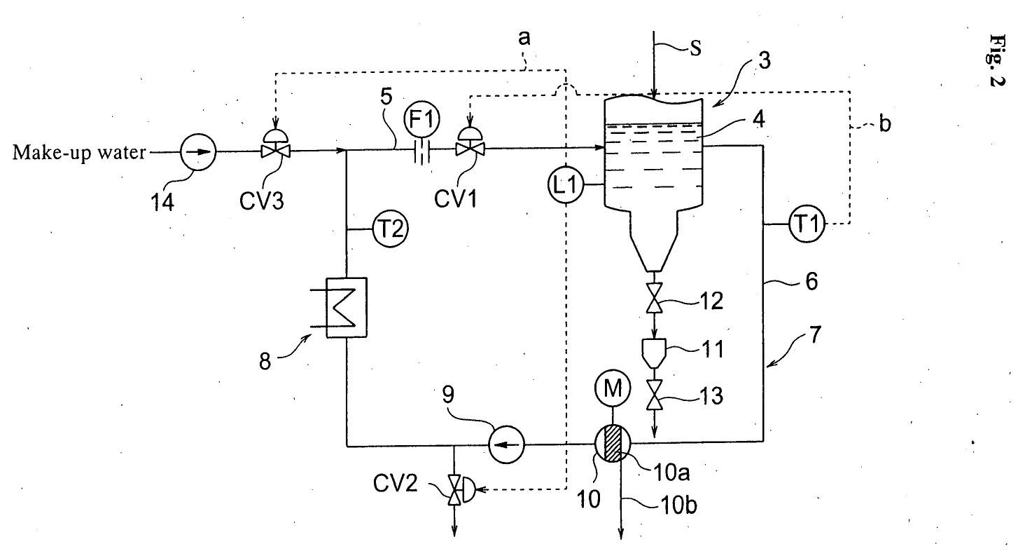

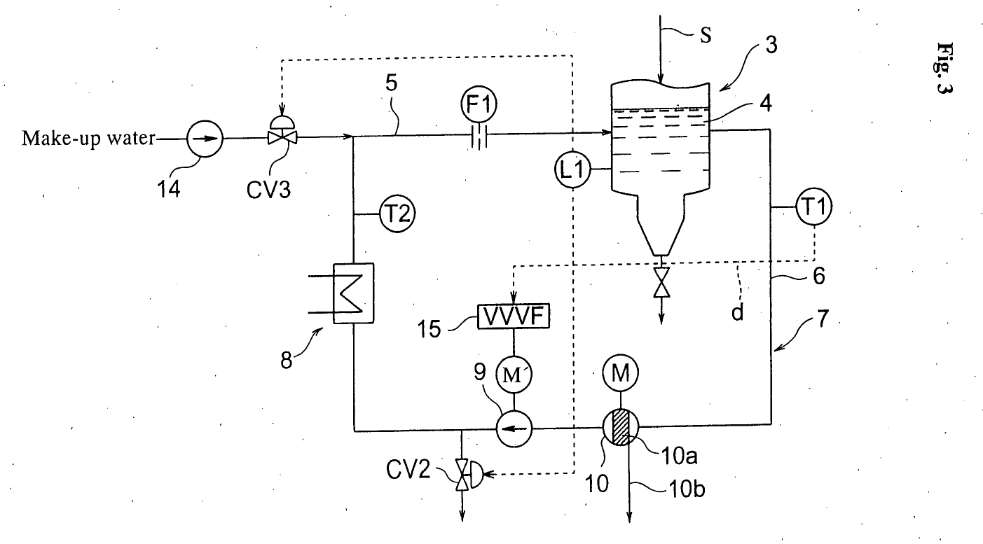

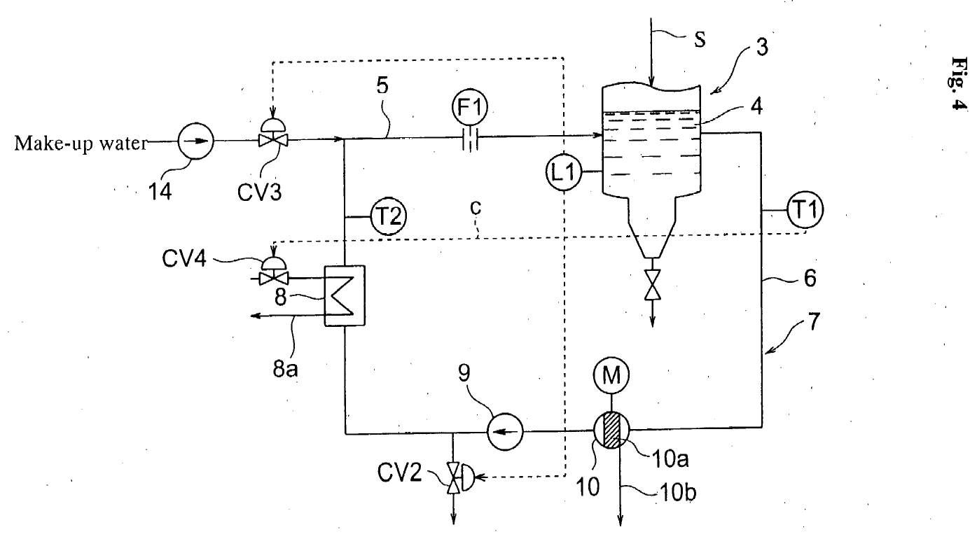

FIGS. 1 to 4 respectively show slag water circulating portions of the pressurized coal gasifier according to the present invention, wherein FIG. 1 is a slag water circulating channel diagram of embodiment 1, FIG. 2 is a slag water circulating channel diagram of embodiment 2, FIG. 3 is a slag water circulating channel diagram of embodiment 3 and FIG. 4 is a slag water circulating channel diagram of embodiment 4.

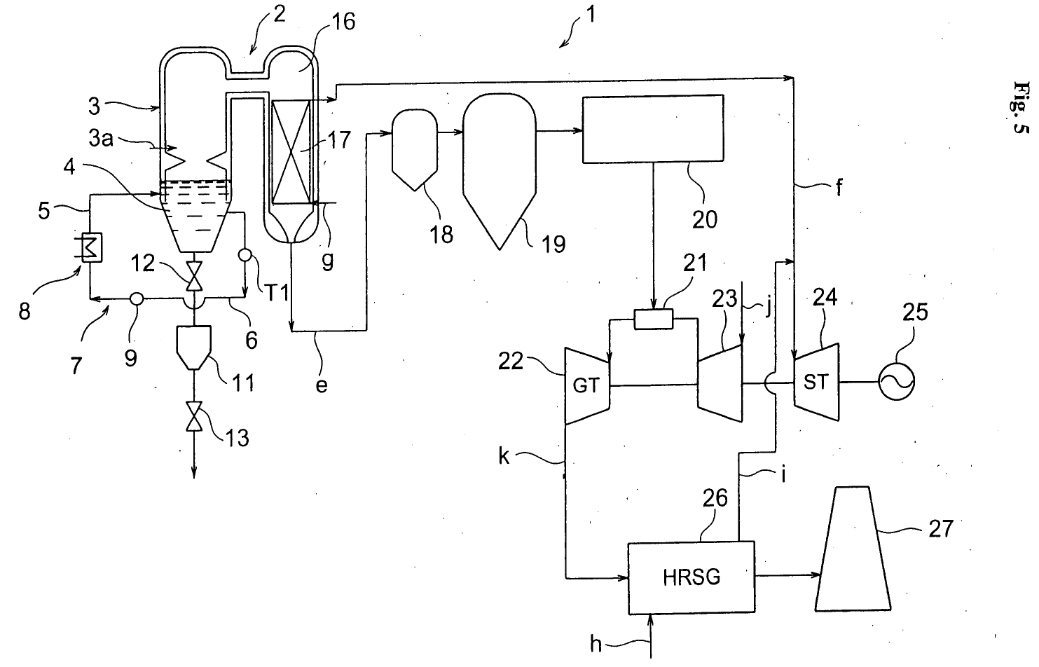

FIG. 5 is an entire system diagram of the coal gasification combined cycle power plant according to the present invention.

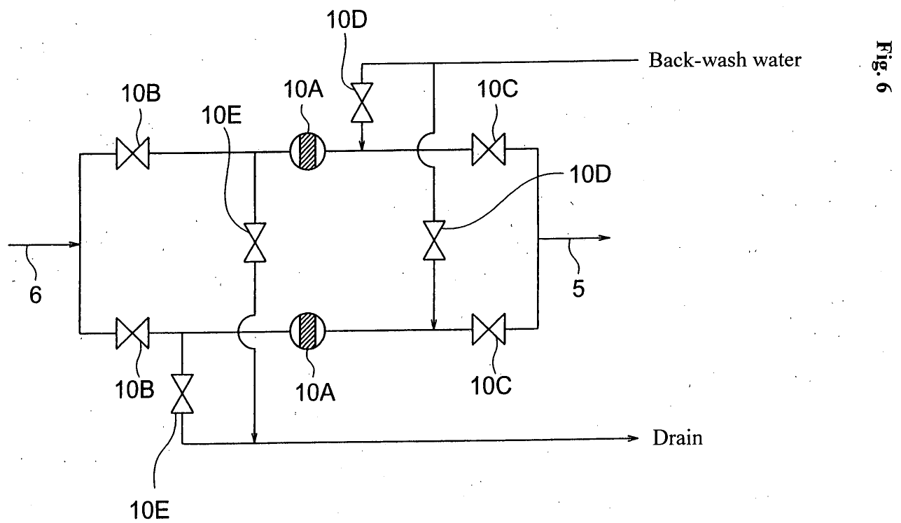

FIG. 6 is a channel diagram of another embodiment of a filter device used in the embodiments 1 to 4 of the pressurized coal gasifier according to the present invention.

The embodiment 1 of the pressurized coal gasifier according to the present invention will be described with reference to FIGS. 1 and 5. A pressurized coal gasifier 2 has one portion thereof shown in FIG. 1 and an entire construction thereof shown in FIG. 5. The pressurized coal gasifier 2 is constructed by a coal material supply pipe 3a for supplying a coal material, gasifier 3 for thermally processing the coal material under pressure to be gasified, water tank 4 provided in a bottom portion of the gasifier 3 for water-granulating a slag, gas discharge channel 16 for discharging gas generated in the gasifier 3 and heat exchanger 17 provided in the gas discharge channel 16.

The coal material fed into the gasifier 3 is a pulverized coal. Also, a coal char collected at a cyclone filter 18 or the like, as shown in FIG. 5, may be fed together into the gasifier 3.

The water tank 4 is connected with one end of a feed water pipe 5 for supplying water and one end of a drain pipe 6 for draining slag water. The other ends of the feed water pipe 5 and drain pipe 6 are connected so as to communicate with each other to thereby form a circulating channel 7 of closed system or to form a closed system with no atmospheric pressure open end portion communicating by one continuous piping channel. In the circulating channel 7, there are provided a circulating water cooler 8, circulating pump 9, filter device 10 that is on-line automatically washable, slag hopper water outlet temperature gauge T1 as a water temperature detector, cooler outlet temperature gauge T2 for monitoring the water channel and circulating water flow meter F1 for monitoring performance (abrasion) of the circulating pump 9 or other states, such as a state that no water flows in the channel while a water level control valve CV3 is opened.

The filter device 10 has an automatic wash function. One example of an automatic wash mechanism is shown in FIG. 1 such that a cylindrical mesh filter 10a is provided in a casing to be axially rotated by a motor M. When the mesh filter 10a comes to face a slag discharge opening of the casing, the mesh filter 10a is back-washed by water so that the slag is discharged outside. As the mesh filter 10a is axially rotated, a slag filtering surface of the mesh filter 10a is always maintained cleanly washed.

A slag hopper water level gauge L1 is fitted to the water tank 4. By a water level signal from the slag hopper water level gauge L1, opening of a water level control valve CV2 and/or water level control valve CV3 is adjusted and controlled so that the water level in the water tank 4 is always maintained above the feed water pipe 5 and drain pipe 6 and the circulating channel 7 is always filled with the water. If the water tank 4 and/or circulating channel 7 becomes short of the water by vaporization or the like, the water level control valve CV3 is opened so that make-up water is supplied into the feed water pipe 5 of the water tank 4 from a make-up water pump 14. Also, if the water tank 4 and/or circulating channel 7 becomes full of the water by flowing-in of a pump shaft seal water or the like, the excess water is discharged through the water level control valve CV2. Flow velocity of the circulating water (slag water) in the circulating channel 7 is controlled to such a velocity as causes no clogging of the piping. Also, the circulating pump 9 is supplied with the minimum quantity of the water. If quantity of the slag component increases, quantity of the water is increased.

A lock hopper 11 for tentatively storing the slag is fitted to a bottom of the water tank 4 via a slag valve 12. A slag discharge valve 13 is provided below the lock hopper 11. In case the slag settled in the water tank 4 is to be discharged, the slag valve 12 is opened so that the slag is received into the lock hopper 11. Then, the slag valve 12 is closed and the slag discharge valve 13 is opened so that the slag is discharged out of the system.

In the meanwhile, as shown in FIG. 5, the coal material from the coal material supply pipe 3a is fed into the gasifier 3 and combustibles in the coal material are converted into gas that is rich with carbon monoxide (CO) and hydrogen (H). Ash component of the coal material becomes a molten slag and the molten slag falls down, as shown by arrow S in FIG. 1, into the water tank 4. There, the molten slag is quenched and water-granulated.

The circularly supplied water is cooled at the cooler 8 so that the water temperature in the water tank 4 is controlled not to become a boiling point temperature at the atmospheric pressure or more. As the slag water discharged from the water tank 4 contains the slag, the slag water before entering the circulating pump 9 is filtered by the filter device 10 so that the slag or the like in the slag water is filtered off and discharged out of the system through a slag discharge pipe 10b of the filter device 10 or sent to a pipe line of the coal material supply pipe 3a as shown in FIG. 5.

It is to be noted that if the circulating pump 9 is of an abrasion resistant type, the filter device 10 may be provided on the downstream side of the circulating pump 9 or according to the case, no filter device 10 may be provided. Also, if the cooler 8 is a tube type or plate type heat exchanger, a filter device may be provided at an inlet of the cooler 8. Also, while the above-mentioned slag hopper water level gauge L1 is of a differential pressure type, the level gauge L1 may be of a pressure type that measures the water level at one point.

In the present embodiment, the circulating channel 7 is made by the closed system. Hence, such a pressure elevation by pumping as carried out by the conventional large capacity high head pump or by pumps arranged with multiple stages becomes unnecessary and a general-purpose low head circulating pump 9 can be used. Thereby, not only a reduction of device manufacturing cost but also a reduction of spare parts cost can be achieved.

Also, as the quantity of the slag water discharge into the atmospheric pressure from the high pressure gasifier 3 becomes almost zero as compared with the conventional cases, abrasion of the piping of the circulating channel 7 as well as abrasion of the circulating pump 9 itself hardly occur and there is obtained an effect that a long term continuous operation of the gasifier 3 becomes possible. Also, as the slag water is used by the circulation, quantity of the water used can be made less and load of the waste water treating facilities can be reduced, which is preferable also from the viewpoint of the environment preservation. Further, as the temperature of the water in the water tank 4 is controlled to be lower than the boiling point temperature at the atmospheric pressure (100° C. at 1 atm), no flushing phenomenon is caused and abrasion damage of the piping system due to flushing can be prevented.

Next, the embodiment 2 of the pressurized coal gasifier according to the present invention will be described with reference to FIG. 2.

In the present embodiment, while the device construction of the gasifier 3, water tank 4, circulating channel 7, etc. is the same as that of the embodiment 1, there is additionally provided a temperature adjusting means for controlling opening of a circulating water flow control valve CV1, based on a temperature signal b from the slag hopper water outlet temperature gauge T1. This control by the temperature signal b from the slag hopper water outlet temperature gauge T1 is for controlling the water temperature in the water tank 4 to be lower than the boiling point temperature of the water at the atmospheric pressure, wherein a set temperature of the water at an installation position of the slag hopper water outlet temperature gauge T1 is in the range of 30 to 70° C. If the water temperature exceeds this set temperature, the circulating water flow control valve CV1 is controlled toward an opening direction. If the water temperature becomes lower than the set temperature, the circulating water flow control valve CV1 is controlled toward a closing (throttling) direction. It is to be noted that if the set temperature is set to a higher temperature side than a lower temperature side, needed quantity of the circulating water can be made less and as the result, quantity of the water contaminated after used can be made less.

If the water temperature in the water tank 4 becomes the boiling point temperature at the atmospheric pressure or more, by the flushing phenomenon occurring at the time when the slag is discharged out of the system, there is caused the problem of abrasion in the pipe line, especially in the slag discharge valve 13 of the lock hopper 11. Nevertheless, in the present embodiment, this problem can be solved by the temperature control of the water in the water tank 4. Also, in the present embodiment, clogging of the filter 10a can be made less and blockade thereof can be avoided. Further, if the circulating water flow control valve CV1 is controlled toward the throttling direction, pressure loss is increased and quantity of the water flowing through the circulating pump 9 is decreased. Hence, there are obtained a function and effect to reduce the power to drive the circulating pump 9.

In the present embodiment, quantity of the circulating water can be made the necessary minimum. Also, by maintaining the water temperature in the water tank 4 to the set temperature of 30 to 70° C., the slag can be water granulated to particles of comparatively small size.

The embodiment 3 of the pressurized coal gasifier according to the present invention will be described with reference to FIG. 3.

In the present embodiment, while the device construction of the gasifier 3, water tank 4, circulating channel 7, etc. is the same as that of the embodiment 1, there is additionally provided a temperature adjusting means for adjusting a drive of the circulating pump 9 by a motor M′ controlled by an inverter 15 to thereby control a pump discharge quantity thereof to be increased or decreased, based on a temperature signal d from the slag hopper water outlet temperature gauge T1. It is to be noted that, in place of the inverter 15, a variable coupling device, such as a fluid coupling, may be used.

This control by the temperature signal d from the slag hopper water outlet temperature gauge T1 is for controlling the water temperature in the water tank 4 to be lower than the boiling point temperature of the water at the atmospheric pressure, wherein a set temperature of the water at an installation position of the slag hopper water outlet temperature gauge T1 is in the range of 30 to 70° C. If the water temperature exceeds this set temperature, the circulating pump 9 is controlled to be more strongly driven to thereby increase the circulating water quantity. If the water temperature becomes lower than the set temperature, the circulating pump 9 is controlled to be weakly driven to thereby decrease the circulating water quantity. Thus, the water temperature in the water tank 4 is maintained to be lower than the boiling point temperature of the water at the atmospheric pressure.

If the water temperature in the water tank 4 becomes the boiling point temperature at the atmospheric pressure or more, by the flushing phenomenon occurring at the time when the slag is discharged out of the system, there is caused the problem of abrasion in the pipe line, especially in the slag discharge valve 13 of the lock hopper 11. Nevertheless, in the present embodiment, this problem can be solved by the temperature control carried out such that the circulating water flow rate is increased or decreased to thereby control the water temperature in the water tank 4 to be lower than the boiling point temperature at the atmospheric pressure.

In the present embodiment, quantity of the circulating water can be made the necessary minimum. Also, by maintaining the water temperature in the water tank 4 to the set temperature of 30 to 70° C., the slag can be water-granulated to particles of comparatively small size.

The embodiment 4 of the pressurized coal gasifier according to the present invention will be described with reference to FIG. 4.

In the present embodiment, while the device construction of the gasifier 3, water tank 4, circulating channel 7, etc. is the same as that of the embodiment 1, there is additionally provided a temperature adjusting means for controlling opening of a cooling medium flow control valve CV4 provided in a cooling medium channel 8a of the cooler 8, based on a temperature signal c from the slag hopper water outlet temperature gauge T1.

This control by the temperature signal c from the slag hopper water outlet temperature gauge T1 is for controlling the water temperature in the water tank 4 to be lower than the boiling point temperature of the water at the atmospheric pressure, wherein a set temperature of the water at an installation position of the slag hopper water outlet temperature gauge T1 is in the range of 30 to 70° C. If the water temperature exceeds this set temperature, the cooling medium flow control valve CV4 is controlled toward an opening direction. If the water temperature becomes lower than the set temperature, the cooling medium flow control valve CV4 is controlled toward a closing (throttling) direction.

That is, if the cooling medium flow control valve CV4 of the cooler 8 is opened, cooling medium flows more so that the circulating water flowing through the cooler 8 is cooled more. Reversely, if the cooling medium flow control valve CV4 is controlled toward the throttling direction, cooling of the circulating water is weakened. Thus, the water temperature in the water tank 4 can be controlled to be lower than the boiling point temperature at the atmospheric pressure.

If the water temperature in the water tank 4 becomes the boiling point temperature at the atmospheric pressure or more, by the flushing phenomenon occurring at the time when the slag is discharged out of the system, there is caused the problem of abrasion in the pipe line, especially in the slag discharge valve 13 of the lock hopper 11. Nevertheless, in the present embodiment, this problem can be solved by the temperature control as mentioned above.

In the present embodiment, quantity of the circulating water flowing in the circulating channel 7 can be always constantly set to the necessary minimum. Also, by maintaining the water temperature in the water tank 4 to the set temperature of 30 to 70° C., the slag can be water-granulated to particles of comparatively small size.

It is to be noted that the circulating water temperature control by the embodiment 4 may be combined with the circulating water flow control by the embodiments 2 and/or 3 so that both of the controls are carried out at the same time or either of them is carried out by change-over. Also, in the embodiments 1 to 4 of the pressurized coal gasifier as mentioned above, while the slag hopper water outlet temperature gauge T1 is provided in the circulating water channel 7, it is also possible that the slag hopper water outlet temperature gauge T1 is provided in the water tank 4 of the gasifier 3.

As mentioned above, the pressurized coal gasifiers of the embodiments according to the present invention are constructed by the circulating pump 9, cooler 8, control valves (CV1 to CV4), filter device 10, etc. and provide the system in which the slag hopper water (water in the water tank 4) is cooled and the slag water is circulated in order to maintain the necessary water level of the slag hopper water. Also, in the slag water circulating system, the filter 10a that is automatically washable, such as an automatic wash type filter, is provided. Moreover, specification of the cooler 8 and circulating pump 9 is decided so as to maintain the slag hopper water outlet temperature to 70° C. or less and the water is circulated by the circulating pump 9. While the slag hopper water outlet temperature is changed by the slag quantity, flow rate of the circulating water can be controlled by the circulating pump 9. Water level of the slag hopper water (water in the water tank 4) is adjusted by the make-up water quantity and outside blow quantity controlled by the water level control valves (CV2 to CV3).

Also, in order to reduce abrasion of the pump, etc. or to reduce load of the filter, if the thermal load by the slag is small, flow rate of the circulating water is reduced. That is, the slag hopper water outlet temperature is controlled to become constant by the circulating water flow control valve CV1. If the heat input from the gasifier is small, while the circulating water quantity is made less, operation is made so as to ensure a minimum flow quantity by the circulating water flow meter F1. Thereby, the slag water temperature is securely detected by the slag hopper water outlet temperature gauge T1 so that overheat of the pump and foreign matter sedimentation in the piping can be sufficiently prevented. Water level of the slag hopper water (water in the water tank 4) is likewise adjusted by the make-up water quantity and outside blow quantity controlled by the water level control valves (CV2 and CV3).

According to the pressurized coal gasifiers of the present embodiments, employment of a large capacity high head pump for supplying the slag water containing the slag becomes unnecessary. Also, as the slag water discharge quantity from the high pressure gasifier into the atmospheric pressure becomes less, the piping and pump are hardly abraded. Hence, maintenance cost of the piping and pump can be reduced and cost of spare parts can be also reduced. Further, as the risk to replace the piping is reduced and the high pressure pump can be employed from low head circulating pumps, there is obtained an effect to reduce the motor capacity as well as reduce the auxiliary machine drive power.

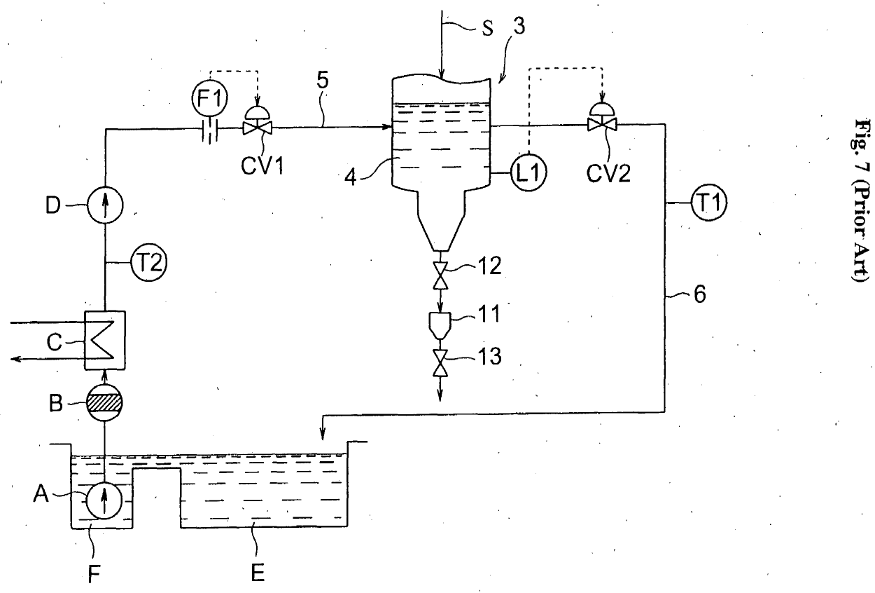

It is to be noted that while the temperature adjusting means of the embodiments 2 to 4 can have the largest effect if they are provided in the closed system circulating channel as shown in FIG. 1, they may also be provided in the open system circulating channel as shown in FIG. 7. In this case also, a certain effect can be expected.

Also, in place of the filter device 10 as shown in FIGS. 1 to 4, such a filter device as shown in FIG. 6 can be used. That is, the filter device comprises a combination of two systems arranged in parallel. Each of the systems comprises a general back-wash filter 10A and an inlet valve 10B and outlet valve 10C thereof. By closing the inlet valves 10B and outlet valves 10C and opening back-wash water inlet valves 10D and back-wash water outlet valves 10E, back-wash water is supplied to the outlet side of the filter device 10. Thereby, the back-wash filter 10A of the filter device 10 is back-washed and the dust is removed together with the water.

Next, a coal gasification combined cycle power plant according to the present invention will be described based on an embodiment thereof with reference to FIG. 5. In the present embodiment, a coal gasification combined cycle power plant 1 carries out power generation using any one of the above-mentioned embodiments 1 to 4 of the pressurized coal gasifier.

The coal gasification combined cycle power plant 1 comprises the heat exchanger 17 provided in the gas discharge channel 16 of the pressurized coal gasifier 2, a dust collector comprising the cyclone filter 18 and a porous filter 19 for removing dust in the gas discharged from the gas discharge channel 16 via a piping e, a gas turbine 22 driven by pressurized gas supplied from the dust collector via a gas refiner 20 and combustor 21 and a heat recovery steam generator 26 for recovering waste heat of the discharge gas supplied through a discharge gas pipe k after the gas is used for driving the gas turbine 22. Also, the power plant 1 comprises a steam turbine 24 driven by generated steam supplied from the heat exchanger 17 of the pressurized coal gasifier 2 via a piping f as well as generated steam supplied from the heat recovery steam generator 26 via a piping i and a generator 25 for generating power by drive force of the gas turbine 22 and steam turbine 24.

The gas after used for driving the gas turbine 22 is discharged from a stack 27 via the heat recovery steam generator 26. In FIG. 5, letter g designates a feed water pipe of the heat exchanger 17, letter h a feed water pipe of the heat recovery steam generator 26 and letter j an atmospheric air supply duct of a compressor 23.

In the present coal gasification combined cycle power plant 1, dust (char) in the slag gas produced by the pressurized coal gasifier 2 is recovered by the dust collector (18, 19) and then the gas turbine 22 is driven for power generation by the gas after the dust is removed. Also, by the generated gas from the heat exchanger 17 of the pressurized coal gasifier 2, the steam turbine 24 is driven for power generation.

According to the coal gasification combined cycle power plant 1 of the present invention, gas energy produced by the pressurized coal gasifier 2 can be efficiently used. Also, the power can be stably generated for a long period and elongation of the maintenance period becomes possible.

It is to be noted that in the above embodiment, while the steam from the piping f is first supplied into the steam turbine 24, the steam may be first supplied into the heat recovery steam generator 26 for heating thereof and then supplied into the steam turbine 24.

Also, the present invention is applicable to a stack gas desulfurizing type coal gasification combined cycle [or stack gas desulfurizing type integrated gasification combined cycle (IGCC)] power plant as disclosed by the Japanese patent application 2004-188888 of the applicants here. In this case, the gas refining at the front stage of the gas turbine 22, as mentioned above, is not carried out but a desulfurizing treatment at the rear stage of the gas turbine 22 is carried out.

While the present invention has been described based on the embodiments, the present invention is by no means limited thereto but may be added with various design modifications. Also, the respective construction elements of the above embodiments may include such ones as easily thought of or as substantially the same as thought of by a person skilled in the field.

1. A pressurized coal gasifier for thermally processing a coal material under pressure to be gasified, said gasifier having a bottom portion thereof provided with a water tank for water-granulating a slag, said water tank being connected with one end of a feed water pipe and one end of a drain pipe, wherein the other ends of said feed water pipe and drain pipe are connected so as to communicate with each other to form a circulating channel of closed system and said circulating channel is provided with a cooler and circulating pump of circulating water.

2. A pressurized coal gasifier as claimed in claim 1, wherein said water tank or circulating channel is provided with a water temperature detecting device and there is provided a temperature adjusting means for adjusting water temperature in said water tank to a predetermined set temperature based on a temperature signal from said water temperature detecting device.

3. A pressurized coal gasifier as claimed in claim 2, wherein said circulating channel is provided with a circulating water flow control valve and said circulating water flow control valve is controlled to be opened or closed based on the temperature signal from said water temperature detecting device.

4. A pressurized coal gasifier as claimed in claim 2, wherein a discharge quantity of said circulating pump is controlled to be increased or decreased based on the temperature signal from said water temperature detecting device.

5. A pressurized coal gasifier as claimed in claim 2, wherein a cooling medium flow rate of said cooler is controlled to be increased or decreased based on the temperature signal from said water temperature detecting device.

6. A pressurized coal gasifier as claimed in any one of claims 1 to 5, wherein said circulating channel is provided with a filter device that is on-line washable.

7. A coal gasification combined cycle power plant, wherein said power plant comprises the pressurized coal gasifier as claimed in claim 1 as well as comprises a heat exchanger provided in a gas discharge channel of gas gasified by said pressurized coal gasifier, dust collector for removing dust in said gas, gas turbine driven by gas from said dust collector, heat recovery steam generator for generating steam by discharge gas of said gas turbine and steam turbine driven by generated steam from said heat exchanger and heat recovery steam generator, and power is generated by drive force of said gas turbine and steam turbine.

8. A coal gasification combined cycle power plant, wherein said power plant comprises the pressurized coal gasifier as claimed in claim 2 as well as comprises a heat exchanger provided in a gas discharge channel of gas gasified by said pressurized coal gasifier, dust collector for removing dust in said gas, gas turbine driven by gas from said dust collector, heat recovery steam generator for generating steam by discharge gas of said gas turbine and steam turbine driven by generated steam from said heat exchanger and heat recovery steam generator, and power is generated by drive force of said gas turbine and steam turbine.

9. A coal gasification combined cycle power plant, wherein said power plant comprises the pressurized coal gasifier as claimed in claim 3 as well as comprises a heat exchanger provided in a gas discharge channel of gas gasified by said pressurized coal gasifier, dust collector for removing dust in said gas, gas turbine driven by gas from said dust collector, heat recovery steam generator for generating steam by discharge gas of said gas turbine and steam turbine driven by generated steam from said heat exchanger and heat recovery steam generator, and power is generated by drive force of said gas turbine and steam turbine.

10. A coal gasification combined cycle power plant, wherein said power plant comprises the pressurized coal gasifier as claimed in claim 4 as well as comprises a heat exchanger provided in a gas discharge channel of gas gasified by said pressurized coal gasifier, dust collector for removing dust in said gas, gas turbine driven by gas from said dust collector, heat recovery steam generator for generating steam by discharge gas of said gas turbine and steam turbine driven by generated steam from said heat exchanger and heat recovery steam generator, and power is generated by drive force of said gas turbine and steam turbine.

11. A coal gasification combined cycle power plant, wherein said power plant comprises the pressurized coal gasifier as claimed in claim 5 as well as comprises a heat exchanger provided in a gas discharge channel of gas gasified by said pressurized coal gasifier, dust collector for removing dust in said gas, gas turbine driven by gas from said dust collector, heat recovery steam generator for generating steam by discharge gas of said gas turbine and steam turbine driven by generated steam from said heat exchanger and heat recovery steam generator, and power is generated by drive force of said gas turbine and steam turbine.

12. A coal gasification combined cycle power plant, wherein said power plant comprises the pressurized coal gasifier as claimed in claim 6 as well as comprises a heat exchanger provided in a gas discharge channel of gas gasified by said pressurized coal gasifier, dust collector for removing dust in said gas, gas turbine driven by gas from said dust collector, heat recovery steam generator for generating steam by discharge gas of said gas turbine and steam turbine driven by generated steam from said heat exchanger and heat recovery steam generator, and power is generated by drive force of said gas turbine and steam turbine.
